(19) United States
(12) Patent Application Publication
(10) Pub. No.: US 2006/0290712 A1
(43) Pub. Date: Dec. 28, 2006

(54) Method and system for transforming adaptively visual contents according to user's symptom characteristics of low vision impairment and user's presentation preferences

(75) Inventors: Jin-Woo Hong, Daejon-shi (KR); Seung-Ji Yang, Kangwon-do (KR); Yong-Man Ro, Daejon-shi (KR); Je-Ho Nam, Seoul (KR); Jin-Woong Kim, Daejon-si (KR); Chaon-Seop Kim, Daejon-si (KR)

Correspondence Address: MACPHERSON KWOK CHEN & HEID LLP, 2033 GATEWAY PLACE, SUITE 400, SAN JOSE, CA, 95110, US

(73) Assignees: ELECTRONICS AND TELECOMMUNICATIONS RESEARCH INSTITUTE, GAJEONG-DONG, YUSEONG-GU, DAEJEON-SI (KR); HICHEMTECH, INC., GYUNGGI-DO, (KR); RESEARCH AND INDUSTRIAL COOPERATION GROUP, DAEJON-si (KR)

(21) Appl. No.: 10/531,500

(22) PCT Filed: Oct. 15, 2003
(86) PCT No.: PCT/KR03/02135

§ 371 Date: Aug. 22, 2006

(30) Foreign Application Priority Data
Oct. 16, 2002 (KR) 10-2002-0063153

(51) Int. Cl. G09G 5/00

(52) U.S. Cl. 345/619

(57) ABSTRACT

Disclosed are a method and a system that could adaptively improve the visual quality of people with low-vision impairment, regardless of network and terminal. The low-vision impairment is described by a set of “symptoms” that is semantically defined. As the description tool of low vision impairments, it is flexible and reliable to use the proposed “symptoms” based descriptions rather than individually identified names of eye disease, because the user can describe his/her low-vision impairment by specifying associated symptoms based on his/her own experience. The inputted visual contents are adaptively transformed according to the low vision-impairment.

### TECHNICAL FIELD

The present invention relates to a method and system for adapting visual contents to user's symptom characteristics of low-vision impairment and presentation preferences. Specifically, the invention relates to a method and system for adapting digital visual contents that a user with low-vision impairment wants to use to the user's low-vision impairment property and presentation preferences, to overcome the critical point of recognizing wrong information from the corresponding visual contents, thereby allowing the user to get information that normal users can obtain from the same contents.

### BACKGROUND ART

Motion Picture Expert Group (MPEG) that is a working group of ISO/IEC;JTC1;SC29 is establishing MPEG-21 as a next-generation standard for multimedia framework. MPEG-21 aims at realization of multimedia integrating framework in which multimedia contents can be used freely and conveniently irrespective of wide networks, terminals and user characteristics which exist in different social environments, by integrating standards of the existing MPEG or other standard organizations. Digital item adaptation (part 7) of MPEG-21 is related with adapting multimedia contents (digital items) according to a network, terminal or user's characteristics, which is being standardized. The present invention proposes a method for allowing people with low-vision impairment to see visual information on the basis of the low-vision impairment symptoms, shown in Table 1.

TABLE 1
Typical low-vision impairment symptoms

Loss of fine detail
Lack of contrast
Need of light
Light sensitivity
Loss of peripheral vision field
Loss of center vision filed
Hemianopia

### DISCLOSURE OF THE INVENTION

An object of the present invention is to provide users who have low-vision impairment with the same level of visual contents that normal users can obtain, irrespective of the kinds of low-vision impairment symptoms, regardless of network or terminal.

Another object of the present invention is to provide a method and system for adapting multimedia contents to user's presentation preferences.

To accomplish the objects, the present invention defines the input data description structure of a user's low-vision impairment symptom and presentation preferences, and provides a method and system for adapting digital items according to the user's low-vision impairment property and/or presentation preferences.

The present invention provides a method for adapting visual contents to user's low-vision impairment symptom and presentation preferences, comprising the steps of: receiving visual contents; accepting information about the user's low-vision impairment symptom and presentation preferences and describing the information in a standardized description structure; adapting the received visual contents through a method selected according to the information; and displaying the adapted visual contents to the user.

The information about the user's low-vision impairment symptom includes at least one of information of indicating whether or not left and right eyes are blind, left and right visions, and the kind of the low-vision impairment symptom of the user. The information about the user's low-vision impairment symptom includes a textual or numerical descriptor that describes the degree of the user's low-vision impairment symptom. The information about the user's low-vision impairment symptom includes at least one selected from the group consisting of “loss of fine detail”, “lack of contrast”, “light sensitivity”, “need of light”, “loss of peripheral vision field”, “loss of central vision field” and “loss of half field of vision”.

The information about the user's presentation preferences includes user's contents resource priority preference. The contents resource priority preference has a modality priority preference and a genre priority preference. The contents resource priority preference has an object priority preference.

The step of adapting the visual contents is carried out through at least one technique selected according to the user information from contrast control, sharpness control, brightness control, glare reduction, adjustment of image size, presentation priority and modality transformation.

The present invention also provides a system for adapting visual contents to user's low-vision impairment symptom and presentation preferences, comprising means for receiving visual contents; means for accepting information about the user's low-vision impairment symptom and presentation preferences and storing the information in a standardized description structure; means for adapting the received visual contents through a method selected according to the information; and means for displaying the adapted visual contents to the user.

### BRIEF DESCRIPTION OF THE DRAWINGS

Further objects and advantages of the invention can be more fully understood from the following detailed description taken in conjunction with the accompanying drawings, in which:

FIG. 1 is a block diagram of a system according to the present invention;

FIG. 2 shows a user information description structure according to the present invention;

FIG. 3 shows a structure of description of the degree of a low-vision impairment symptom; and

FIG. 4 is a flow chart for explaining an adaptation method according to an embodiment of the present invention.

### BEST MODE FOR CARRYING OUT THE INVENTION

The present invention will now be described in detail in connection with preferred embodiments with reference to the accompanying drawings. Like reference characters designate corresponding parts throughout several views.

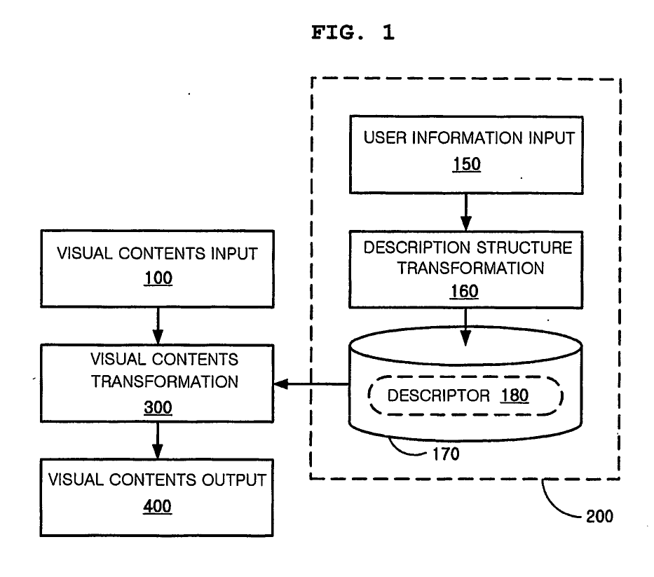

FIG. 1 is a block diagram of a system according to the present invention. As shown in FIG. 1, the system includes a visual contents input unit 100, user information providing unit 200, a visual contents transformation unit 300, and a transformed visual contents output unit 400. The user information providing unit 200 consists of a user information input part 150, a description structure transformation part 160, and a descriptor storage part 180.

First of all, information about a user's low-vision impairment symptom and/or presentation preferences is inputted through the user information input part 150. The user information input part can be composed of a conventional keyboard or a dedicated inspection device. The inputted user information is transformed into a standardized description structure through the description structure transformation part 160. The description structure is standardized so that the information can be used irrespective of the characteristics of network or terminal. The user information is compatible with the visual contents transformation unit 300 for adapting visual contents even if the visual contents transformation unit is manufactured by other manufacturers. The user information described in the standardized description structure is called “standard descriptor” hereinafter. The standard descriptor 180 is previously stored in the descriptor storage part 170, and called and read by the visual contents transformation unit 300.

Visual contents the user wants to reproduce are inputted through the visual contents input unit 100 from a wired or wireless network. The visual contents input unit 100 is composed of a network modem conventionally. The inputted visual contents are transmitted to the visual contents transformation unit 300. The visual contents transformation unit 300 receives user information in the form of standard descriptor from the descriptor storage part 170. The visual contents transformation unit 300 adapts the visual contents provided through the visual contents input unit 100 using the user information received from the user information providing unit 200. The adapted visual contents are outputted to the user through the visual contents output unit 400. The visual contents output unit 400 is a monitor such as a cathode ray tube or liquid crystal display, in general.

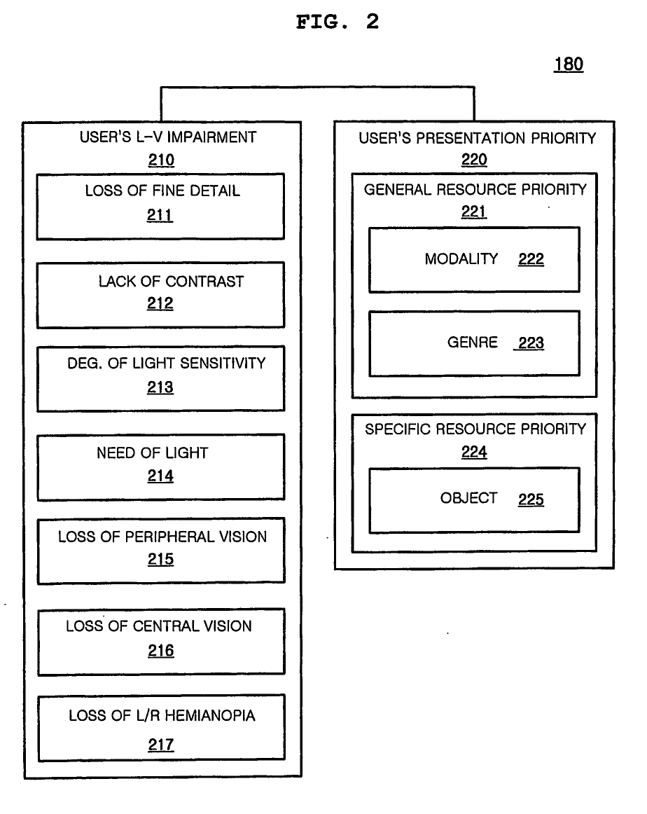

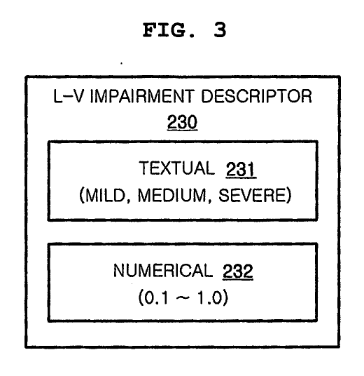

FIG. 2 shows the description structure of the standard descriptor 180 according to the present invention. As shown in FIG. 2, the user information standard descriptor 180 consists of a user's low-vision impairment symptom description part 210 and/or a user's presentation information description part 220. The user's low-vision impairment symptom description part 210 includes a descriptor 211 of describing a degree of loss of fine detail, a descriptor 212 of describing a degree of lack of contrast, a descriptor 213 of representing a degree of light sensitivity, a descriptor 214 of describing a degree of need of light, a descriptor 215 of indicating a degree of loss of peripheral vision field, a descriptor 216 of representing a degree of loss of central vision field, and a descriptor 217 of describing a degree of loss of half filed of hemianopia vision field. Each of the descriptors includes a descriptor 230 for describing a degree of a low-vision impairment symptom, as shown in FIG. 3. The low-vision impairment symptom descriptor 230 is a descriptor for approximately represents a degree of a low-vision impairment symptom and it consists of a textual descriptor 231 that grades the degree of a symptom mild, medium and severe and/or a numerical descriptor 232 that describes the degree of a low-vision impairment symptom in the range of 0.1 to 1.0 in detail.

The user's presentation information description part 220 includes a general resource priority preference 221 and a specific resource priority preference 224. The general resource priority preference 221 has a modality priority preference 224 that represents preference with respect to types of visual contents and a genre priority preference 223 that describes preference for the contents of visual contents. The specific resource priority preference 224 includes a priority preference 255 with respect to a specific object constructing the visual contents.

As people grow older, their visual capabilities deteriorate naturally. However, this variation does not bring about low-vision. Low-vision impairment is caused by ophthalmic diseases including cataract, glaucoma and macular degeneration or serious complications or aftereffects of a traumatic injury as well as congenital impediment in development. Although a considerable part of low-vision impairment can be cured through eyeglasses, medicines or surgical operation, low-vision impairment caused by ophthalmic diseases that are incurable or can be partially cured brings about permanent loss of visual capability.

The present invention includes principal seven low-vision impairment symptoms as descriptors for low-vision impairment properties. A symptom 211 of “loss of fine detail” means blurredness and a symptom 212 of “lack of contrast” describes deterioration in the contrast between light and shade. A symptom 213 of “light sensitivity” represents that light sensitivity is increased to result in stronger rejection to lights, and a symptom 214 of “need of light” describes that light sensitivity is decreased so that larger quantity of lights is needed. In addition, a symptom 215 of “loss of peripheral vision field” represents that a person who has this symptom cannot see the center of an object because a material obstructing the view is formed at the center of his/her eyes. Furthermore, a symptom 216 of “loss of central vision field” describes that a person who has this symptom cannot see the peripheral portion of an object because a material obstructing the view is formed at the peripheral part of his/her eyes. Finally, hemianopia symptom 217 means that a half of vision field is not seen.

Table 2a, 2b and 2c show examples of extensible markup language texts that describe the low-vision impairment symptom description part 210 of FIG. 2.

```
TABLE 2a
<!-- ################################## -->
<!--  Definition of VisualImpairment -->
<!-- ################################## -->
<complexType name=“VisualImpairmentType”>
    <complexContent>
      <extension base=“dia:DIABaseType”>
          <sequence>
            <element name=“Blindness” minOccurs=“0”>
                <complexType>
                  <attribute name=“eyeSide”>
                      <simpleType>
                        <restriction base=“NMTOKEN”>
                            <enumeration value=“both”/>
                            <enumeration value=“left”/>
                            <enumeration value=“right”/>
                        </restriction>
                      </simpleType>
                  </attribute>
                </complexType>
            </element>
            <element name=“LowVisionSymptoms”
                type=“dia:LowVisionImpairmentType”
                minOccurs=“0”/>
            <element name=“ColorVisionDeficiency”
                type=“dia:ColorVisionDeficiencyType”
                minOccurs=“0”/>
          </sequence>
          <attribute name=“rightSight” type=“float” use=“optional”/>
          <attribute name=“leftSight” type=“float” use=“optional”/>
      </extension>
    </complexContent>
</complexType>
```

```
TABLE 2b
<complexType name=“LowVisionImpairmentType”>
  <complexContent>
    <extension base=“dia:DIABaseType”>
      <sequence>
        <element name=“LossOfFineDetail”
          type=“dia:VisualImpairmentDegreeType” minOccurs=“0”/>
        <element name=“LackOfContrast”
          type=“dia:VisualImpairmentDegreeType” minOccurs=“0”/>
        <element name=“LightSensitivity”
          type=“dia:VisualImpairmentDegreeType” minOccurs=“0”/>
        <element name=“NeedOfLight”
          type=“dia:VisualImpairmentDegreeType” minOccurs=“0”/>
        <element name=“CenterVisionLoss”
          type=“dia:VisualImpairmentDegreeType” minOccurs=“0”/>
        <element name=“PeripheralVisionLoss”
          type=“dia:VisualImpairmentDegreeType” minOccurs=“0”/>
        <element name=“Hemianopia” minOccurs=“0”>
          <complexType>
            <attribute name=“side”>
              <simpleType>
                <restriction base=“NMTOKEN”>
                  <enumeration value=“left”/>
                  <enumeration value=“right”/>
                </restriction>
              </simpleType>
            </attribute>
          </complexType>
        </element>
      </sequence>
    </extension>
  </complexContent>
</complexType>
```

TABLE 2c

```
<complexType name=“VisualImpairmentDegreeType”>
    <complexContent>
        <extension base=“dia:DIABaseType”>
            <choice>
                <element name=“NumericDegree”
                type=“mpeg7:zeroToOneType”/>
                <element name=“TextualDegree”>
                    <simpleType>
                        <restriction base=“NMTOKEN”>
                            <enumeration value=“Severe”/>
                            <enumeration value=“Medium”/>
                            <enumeration value=“Mild”/>
                        </restriction>
                    </simpleType>
                </element>
            </choice>
        </extension>
    </complexContent>
</complexType>
```

```
TABLE 3a
<!-- ################################################### -->
<!--  Definition of PresentationPriorityPreference -->
<!-- ################################################### -->
<complexType name=“PresentationPriorityPreferenceType”>
  <complexContent>
    <extension base=“dia:DIABaseType”>
      <sequence>
        <element name=“GeneralResourcePriorities”
          type=“dia:GeneralResourcePrioritiesType” minOccurs=“0”/>
        <element name=“SpecificResourcePriorities”
          type=“dia:SpecificResourcePrioritiesType” minOccurs=“0”/>
      </sequence>
    </extension>
  </complexContent>
</complexType>
<complexType name=“GeneralResourcePrioritiesType”>
  <complexContent>
    <extension base=“dia:DIABaseType”>
      <sequence>
        <element name=“ModalityPriorities”
          type=“dia:ModalityPrioritiesType” minOccurs=“0”/>
        <element name=“GenrePriorities”
          type=“dia:GenrePrioritiesType” minOccurs=“0”/>
      </sequence>
    </extension>
  </complexContent>
</complexType>
<complexType name=“SpecificResourcePrioritiesType”>
  <complexContent>
    <extension base=“dia:DIABaseType”>
      <sequence>
        <element name=“Object” minOccurs=“0”
        maxOccurs=“unbounded”>
          <complexType>
            <attribute name=“priorityLevel”
              type=“mpeg7:nonNegativeReal”
              use=“optional” default=“1.0”/>
              <attribute name=“target”
              type=“anyURI” use=“required”/>
          </complexType>
        </element>
      </sequence>
    </extension>
  </complexContent>
</complexType>
```

```
TABLE 3b
<complexType name=“ModalityPrioritiesType”>
  <complexContent>
    <extension base=“dia:DIABaseType”>
      <sequence>
        <element name=“Modality” minOccurs=“0”
          maxOccurs=“unbounded”>
          <complexType>
            <complexContent>
              <extension base=“mpeg7:ControlledTermUseType”>
                <attribute name=“priorityLevel”
                  type=“mpeg7:nonNegativeReal” use=“optional”
                  default=“1.0”/>
              </extension>
            </complexContent>
          </complexType>
        </element>
      </sequence>
    </extension>
  </complexContent>
</complexType>
<complexType name=“GenrePrioritiesType”>
  <complexContent>
    <extension base=“dia:DIABaseType”>
      <sequence>
        <element name=“Genre” minOccurs=“0”
        maxOccurs=“unbounded”>
          <complexType>
            <complexContent>
              <extension base=“mpeg7:ControlledTermUseType”>
                <attribute name=“priorityLevel”
                  type=“mpeg7:nonNegativeReal” use=“optional”
                  default=“1.0”/>
              </extension>
            </complexContent>
          </complexType>
        </element>
      </sequence>
    </extension>
  </complexContent>
</complexType>
```

Table 3a and 3b are examples of extensible markup language texts that describe the user's presentation information description part 220 shown in FIG. 2.

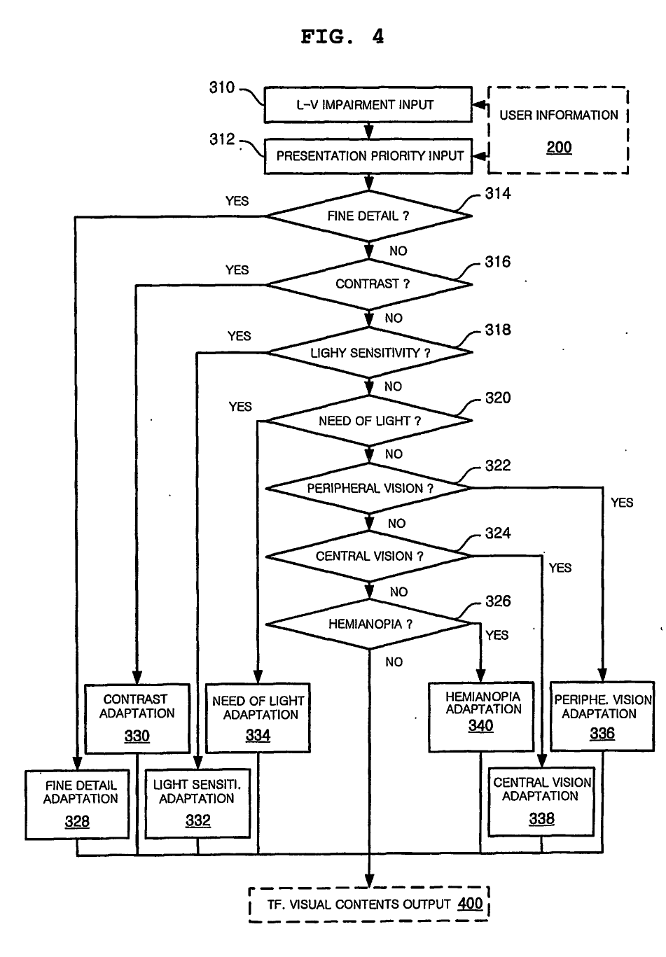

FIG. 4 is a flow chart for explaining an adaptation method according to an embodiment of the present invention. When the visual contents input unit 200 transmits contents to the visual contents transformation unit 300, the visual contents transformation unit 300 receives low-vision impairment property in the form of standard describer from the user information providing unit 200 at step 310 and accepts information about user's presentation preferences at step 312. Then the visual contents transformation unit 300 extracts information about a user's low-vision impairment symptom and a degree of seriousness of the symptom from the low-vision impairment property and selects an adaptation method suitable for the symptom to adapt the visual contents. For example, the visual contents transformation unit judges whether or not the user has the symptom of “loss of fine detail” at step 314, and performs adaptation for “loss of fine detail” at step 328 on case that the user has the symptom of “loss of fine detail”. In the case that the user does not have the symptom of “loss of fine detail”, the visual contents transformation unit judges whether or not the user has the other low-vision impairment symptoms. In this manner, the visual contents transformation unit 300 sequentially judges if the user has the symptoms of “lack of contrast”, “light sensitivity”, “need of light”, “loss of peripheral vision field”, “loss of central vision field”, and “hemianopia” through steps 316, 318, 320, 322, 324 and 326, and carries out adaptation for the symptoms according to the results of the judgments at steps 330, 332, 334, 336, 338 and 340. The adapted visual contents are provided to the visual contents output unit 400 to be displayed.

Visual contents adaptation techniques for compensating the low-vision impairment symptoms include contrast control, sharpness control, brightness control, glare reduction, adjustment of image size, presentation priority and modality transformation. The contrast control enhances the contrast of visual contents according to user's level of impairment. Black and while image transformation is the extreme case of contrast enhancement in case of very serious low-vision impairment. The sharpness control enhances the visibility of the edges in the image/video by emphasizing the high frequencies of the visual contents according to user's low-vision impairment symptoms. The brightness control adjusts the brightness of the contents according to user's low-vision impairment symptom. The brightness control consists of two aspects; i) one is the decrease of the brightness to adapt to the “light sensitivity” symptom 213, and ii) the other is the increase of the brightness to adapt to “need of light” symptom 214.

The glare reduction is used when users have difficult in seeing visual contents due to the glaring effect of the visual contents. For this technique, a special technique called “homomorphic” filter can be used to reduce the illuminance of the high-intensity region in the visual contents while increasing the sharpness (clearness) of the low-intensity region. The adjustment of image size changes the size of image of visual contents to obtain various resized images; e.g., reduced, enlarged and contracted (resized aspect ratio) versions. This technique is effectively applied for the “loss of peripheral vision field” symptom 215, loss of central vision field symptom 216 and “hemianopia” symptom 217.

The presentation priority enhances the perceptibility of certain contents objects according to user's capability and user's interest, meanwhile some less important objects can be left intact or provided in low quality. For example when a low-vision user is interested in text contents, the text (including text image) while be enhanced, audio contents may be enhanced as well (if the user has no problem in hearing), while the image contents may be discarded or given in low quality. The adaptation level to each content object depends on its priority. Specifically, the content objects of high priorities will be enhanced and allocated more resources which results in higher qualities.

The “modality transformation” technique transforms the modalities of contents to other modalities that are appropriate to low-vision user, without changing the semantics of the contents. For example when the user is nearly blind but has no hearing problem, the visual contents can be transformed into audio contents describing the same information.

Table 4 shows the priority of the adaptation techniques for the low-vision impairment symptoms, according to the present invention. Contrast control (CC), sharpness control (SC), brightness control (BC), glare reduction (GR), adjustment of image size (AIS), presentation priority (PP), and modality transformation (MC) are used as the adaptation techniques of the present invention. Also, the technique with the mark “*” is used more significantly than the technique with the mark “**”. The mark “∘” indicates that the corresponding adaptation technique can be used for all of the symptoms. That is, the “presentation priority” and “modality transformation” techniques can be applied for all of the low-vision impairment symptoms.

TABLE 4

| | CC | SC | BC | GR | AIS | PP | MC |
|---|---|---|---|---|---|---|---|
| Loss of fine detail | ** | ** | * | | ** | ◯ | ◯ |
| Lack of contrast | ** | * | * | | ** | ◯ | ◯ |
| Light sensitivity | * | * | ** | ** | * | ◯ | ◯ |
| Need of light | * | | ** | | * | ◯ | ◯ |
| Loss of peripheral | * | * | * | | ** | ◯ | ◯ |
| vision field | | | | | | | |
| Loss of central vision field | * | * | * | | ** | ◯ | ◯ |
| Hemianopia | * | * | * | | ** | ◯ | ◯ |

For the “loss of fine detail” symptom 211, contrast control, sharpness control, brightness control and adjustment of image size can be applied. Especially, contrast control, sharpness control and adjustment of image size have higher priorities. In case of the “lack of contrast” symptom 212, the techniques of contrast control, sharpness control, brightness control and adjustment of image size can be used. Here, the contrast control and adjustment of image size take precedence of other techniques.

For the “light sensitivity” symptom 213, contrast control, sharpness control, brightness control, glare reduction and adjustment of image size can be applied. In this case, the brightness control and glare reduction can be carried out preferentially. In case of the “need of light” symptom 214, the techniques of contrast control, sharpness control, brightness control, glare reduction and adjustment of image size can be used. Here, the brightness control and glare reduction take precedence of the other techniques.

Contrast control, sharpness control, brightness control and adjustment of image size can be applied for the “loss of peripheral vision field” symptom 215. In this case, the adjustment of image size has priority higher than those of other techniques. For the “loss of central vision field” symptom 216, contrast control, sharpness control, brightness control and adjustment of image size can be applied. Here, the adjustment of image size takes precedence of the other techniques. Finally, in case of the “hemianopia” symptom 217, contrast control, sharpness control, brightness control and adjustment of image size can be used and the image size adjustment technique can be preferentially executed.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

As described above, according to the present invention, even low-vision users are provided with the same significance information of visual contents that normal users can accept without using an additional device so that the low-vision users can use multimedia contents freely and conveniently. The present invention can be applied for digital item adaptation of International standard MPEG-7 and MPEG 21.

What is claimed is:

1. A method for adapting visual contents to user's low-vision impairment symptom and presentation preferences, comprising the steps of:
receiving visual contents;
accepting information about the user's low-vision impairment symptom and presentation preferences and describing the information in a standardized description structure;
adapting the received visual contents through a method selected according to the information; and
displaying the adapted visual contents to the user.

2. The method as claimed in claim 1, wherein the information about the user's low-vision impairment symptom includes at least one of information of indicating whether or not left and right eyes of the user are blind, left and right visions of the user, and the kind of the low-vision impairment symptom of the user.

3. The method as claimed in claim 1, wherein the information about the user's low-vision impairment symptom includes a textual or numerical descriptor that describes a degree of the user's low-vision impairment symptom.

4. The method as claimed in claim 1, wherein the information about the user's low-vision impairment symptom includes at least one selected from the group consisting of a degree of “loss of fine detail”, a degree of “lack of contrast”, a degree of “light sensitivity”, a degree of “need of light”, a degree of “loss of peripheral vision field”, a degree of “loss of central vision field” and a degree of “loss of half field of vision”.

5. The method as claimed in claim 1, wherein the information about the user's presentation preferences includes user's contents resource priority preference.

6. The method as claimed in claim 5, wherein the contents resource priority preference has a modality priority preference and a genre priority preference.

7. The method as claimed in claim 5, wherein the contents resource priority preference has an object priority preference.

8. The method as claimed in claim 1, wherein the step of adapting the visual contents is carried out through at least one technique selected according to the user information from contrast control, sharpness control, brightness control, glare reduction, adjustment of image size, presentation priority and modality transformation.

9. A method for adapting visual contents to user's low-vision impairment symptom, comprising the steps of:
receiving visual contents;
accepting information about the user's low-vision impairment symptom and describing the information in a standardized description structure;
adapting the received visual contents according to the user information having the standardized description structure; and
displaying the adapted visual contents to the user.

10. The method as claimed in claim 9, wherein the information about the user's low-vision impairment symptom includes at least one selected from the group consisting of a degree of “loss of fine detail”, a degree of “lack of contrast”, a degree of “light sensitivity”, a degree of “need of light”, a degree of “loss of peripheral vision field”, a degree of “loss of central vision field” and a degree of “loss of half field of vision”.

11. A method for adapting visual contents to user's presentation preferences, comprising the steps of:
receiving visual contents;
accepting information about the user's presentation preferences and describing the information in a standardized description structure;
adapting the received visual contents according to the user information having the standardized description structure; and
displaying the adapted visual contents to the user.

12. The method as claimed in claim 11, wherein the information about user's presentation preferences includes user's contents resource priority preference.

13. The method as claimed in claim 12, wherein the contents resource priority preference has a modality priority preference and a genre priority preference.

14. A system for adapting visual contents to user's low-vision impairment symptom and presentation preferences, comprising:
means for receiving visual contents;
means for accepting information about the user's low-vision impairment symptom and presentation preferences and storing the information in a standardized description structure;
means for adapting the received visual contents through a method selected according to the information; and
means for displaying the adapted visual contents to the user.

15. The system as claimed in claim 14, wherein the information about the user's low-vision impairment symptom includes at least one selected from the group consisting of a degree of “loss of fine detail”, a degree of “lack of contrast”, a degree of “light sensitivity”, a degree of “need of light”, a degree of “loss of peripheral vision field”, a degree of “loss of central vision field” and a degree of “loss of half field of vision”.

16. The system as claimed in claim 14, wherein the information about user's presentation preferences includes a user's contents resource priority preference.

17. The system as claimed in claim 14, wherein the means for adapting the visual contents carries out at least one technique selected according to the user information from contrast control, sharpness control, brightness control, glare reduction, adjustment of image size, presentation priority and modality transformation.
